(19) United States
(12) Patent Application Publication
(10) Pub. No.: US 2009/0018966 A1
(43) Pub. Date: Jan. 15, 2009

(54) Formulation of Optimized Investment Indeces

(76) Inventors: Andrew Clark, Niwest, CO (US); Mark Labovitz, Superior, CO (US)

Correspondence Address: BANNER & WITCOFF, LTD., 1100 13th STREET, N.W., SUITE 1200, WASHINGTON, DC, 20005-4051, US

(21) Appl. No.: 11/776,110

(22) Filed: Jul. 11, 2007

(51) Int. Cl. G06Q 40/00

(52) U.S. Cl. 705/36 R

(57) ABSTRACT

Investment performance indices and methods of their formulation are described. The indices are determined by selecting a representative subset of assets (e.g., exchange-traded index funds) from a relatively larger number of possibilities in a given asset class. A performance index for the asset class is created by determining optimized weightings in each asset in the subset. The weightings can be optimized according to any number of optimization algorithms, including MVO, CVaR, and G-CAPM and tailored to a given investor risk profile. One or more “investor-centered” indices may be generated in this manner, for the asset class.

### FIELD OF THE INVENTION

The present invention relates generally to investment performance indices and methods of their formulation. More specifically, the invention provides methods of creating an index based on optimizing weightings of assets in a representative, meaningful subset of an asset class.

### BACKGROUND OF THE INVENTION

Financial indices have found widespread use in benchmarking the performance of many types of investment vehicles including individual stocks and bonds, mutual funds, hedge funds, real estate, etc. These indices are normally formulated to provide a representation of the behavior of assets or securities (e.g., stocks within a mutual fund), having at least one basis of commonality, such as market capitalization, industry, management type, growth stage, etc.). Therefore, for example, a large-cap U.S. stock mutual fund is generally benchmarked against the widely-known Standard & Poor's 500 Index (or “S&P 500”), which is regarded as fair representation of overall large-cap stock performance. Comparison of an investment or portfolio to the relevant benchmark thus affords a good basis for evaluating whether performance exceeded or fell below the overall market or market sector of interest.

Indices are conventionally formulated in a number of ways, including price weighting, market-capitalization weighting, and market-share weighting. The value, and consequently the performance, of a price-weighted index, such as the Dow Jones Industrial Average or the German DAX 100, is based only on the prices of the component assets. More commonly, however, market-capitalization (or market-value) weighting is used in the determination of index value, in order to account for each asset's contribution to the overall market value of all components assets used in the index. Well-known examples of market-capitalization weighted indices include the S&P 500 Index and the NASDAQ Composite index. The former is also an example of a total return index, in which performance is calculated based on the assumption that all dividends and distributions of the component assets are reinvested. In a market-share weighted index, the price of each component is weighted according to the respective number of shares outstanding.

These and other methods of index formulation are therefore conventionally employed with the purpose of establishing an objective measure of the performance of a market (e.g., the total stock market) or a particular sector (e.g., biotechnology stocks or mid-cap stocks) within a market. Indices used to characterize a market or sector may therefore be referred to as market-based or strategy-based. While these indices provide information pertaining to the past performance (or even future expectations) of an average, hypothetical investor within a market or strategic sector, they unfortunately do not account for the degree of risk that a particular investor would be willing to accept in carrying out an investment plan.

This drawback of conventional index formulation results from the fact that market-value weighting, price-weighting, and other methods, as discussed above, provide index values without regard to their variability or risk, despite the fact that this variability may represent a significantly smaller or larger risk tolerance for a particular investor. Moreover, these conventional methods of index formulation do not attempt to optimize the risk-return characteristics of the portfolio of component assets which contribute to the index. For these reasons, many investment indices may provide little or no value as a performance barometer for the investor having a certain risk profile and also possibly seeking to invest in a more or less efficient (optimized) portfolio.

Portfolio optimization has long been associated with the underlying objective of diversifying the overall firm-specific or nonsystematic risk components of the individual assets to essentially zero. The underlying market (or systematic) risk remains even after extensive asset diversification. However, according to the Capital Asset Pricing Model (CAPM), this portion of risk (unlike firm-specific risk) is compensated for in the marketplace, in the form of a higher expected return. Also, the overall market risk can be tailored to a given investor's degree of risk aversion (e.g., by holding more or less of an essentially risk-free asset such as a money market fund).

The benefits of diversification of firm-specific risk result from the fact that firm-specific influences on individual assets are essentially independent (or at the very least, are not perfectly positively correlated). Also, the risk of a portfolio with less than perfectly correlated assets is always less than the weighted average of the component asset standard deviations. Because the portfolio's expected return is, however, the weighted average of its component expected returns, gains in efficiency (i.e., a higher expected return for a given measure of risk) can invariably be realized by combining such assets. The lower the correlation between the assets, the greater the potential gain in efficiency. In 1952, Harry Markowitz published a formal model of portfolio selection embodying such diversification principles, leading to his 1990 Nobel Prize in economics. See Markowitz, H., “Portfolio Selection,” JOURNAL OF FINANCE, March, 1952. This model, which is the basis for modern portfolio theory (MPT) allows the identification of a set mean-variance efficient (or a mean-variance efficient “frontier” of) portfolios from any group of risky assets.

A number of additional mathematical models of portfolio optimization were developed later, all of which utilize the principles of asset risk and covariance (or correlation). In particular, moments other than the second moment—variance or its square root standard deviation—have been used as measures of risk. This expansion to higher moments and probability distributions other than the normal distribution have significantly widened the universe of assets that can be optimized or included in an optimized portfolio.

Models of portfolio optimization also commonly incorporate the concept of “past as prologue” to describe (and exploit) the behavior of financial markets. This concept is based on the assumption that past changes in market behavior are believed to fairly represent future changes. Thus, future bull and bear markets, as well as future economic and business cycles, will be similar to those of the past, albeit not necessarily of the same duration or magnitude. However through the use of techniques such as Black-Litterman and Bayes-Stein, future expectations of return and risk can be incorporated into the building of optimized portfolios.

There remains a need in the art for methods that allow the formulation of investment indices for an asset class, which are “investor-centered.” This term refers to investment indices which are tailored to an investor's desire to assume a given level of risk while also maximizing portfolio efficiency. There is a further need in the art for such indices, which can be readily prepared for markets or market sectors that include a large “universe,” or asset class, of individual assets which could potentially be used in formulating an index.

### SUMMARY OF THE INVENTION

Aspects of the present invention are associated with “investor-centered” investment performance indices, which have been developed by the initial Assignee under the name Lipper Optimal Indeces™, and methods for formulating them. Advantageously, such investment performance indices can provide meaningful performance benchmarks for investors having a particular risk tolerance or “risk appetite” (and also possibly seeking to maintain a relatively efficient portfolio in which risk that is nonsystematic with respect to the market or market sector of interest is diversified away). Additional aspects of the invention are associated with selection methodologies which allow for the selection of a relatively small subset of assets (or a working group of assets) which are used as a basis for formulating an index from an asset class that contains a large number of individual assets.

Various embodiments of the invention are therefore directed to a method of formulating or computing an investment performance index for an asset class. The method comprises selecting a subset of assets from an asset class and determining optimal investment weightings in each asset in the subset. The optimal investment weightings may be determined or computed, for example, using principles of modern portfolio theory (MPT) or other portfolio optimization techniques. Representative optimization algorithms include Mean Variance Optimization (MVO), Conditional Value at Risk (CVaR), and Generalized Capital Asset Pricing Model (G-CAPM). For any method of optimization employed, the investment weightings that are ascertained determine the value of the investment performance index. Importantly, the investment weightings can be determined for a given risk level, and thus the index itself can be tailored to an investor having a particular risk tolerance (e.g., aggressive, slightly aggressive, moderate, conservative, or very conservative).

The risk level may be quantified by the use of the second moment of the distribution of returns, or higher moments (e.g., the third moment), or by the use of such concepts as expected shortfall or Value At Risk (VaR). In the case where MPT is used for optimization of the investment weightings, the investment weightings may, for example, correspond to a portfolio on a minimum-variance frontier or a constrained minimum-variance frontier of the subset of assets. An example of a constrained minimum-variance frontier is one that is generated subject to the constraint that no investment weightings are negative (i.e., short positions in the assets are excluded). Also, the risk level may be associated with a particular degree of divergence from a tangent portfolio on a minimum-variance frontier or a constrained minimum-variance frontier that is generated from the selected subset of assets used in formulating the index. According to other aspects of the invention, the risk level may be expected shortfall and the optimal investment weightings are determined based on minimization of a loss level (e.g., as stated by an investor initially). The use of higher moments (those above the second) may also be based upon investor preference (i.e., avoiding or minimizing a certain kind of risk or combination of risks).

The methods can be applied to a wide range of asset classes and/or asset types, for which the investment performance index is determined. One representative asset class, for example, is index funds, of which over 200 are currently available in the U.S. as exchange-traded funds (ETFs). Using the methods described herein, for example, various subsets of these funds comprising at most about 30 ETFs, have been found to adequately describe the behavior of the asset class as a whole.

According to other aspects of the invention, the methodology employed in the selection of a subset of assets (i.e., the selection methodology) from within an asset class comprises utilizing the covariance and/or correlation between performance parameters of the assets in the asset class. These performance parameters may be used in one or more statistical analysis performed as part of the selection methodology, where the statistical analyses involve, for example, principal component analysis, factor analysis, cluster analysis, or combinations of these. Often, the relevant performance parameters utilized in such analyses are historical prices or returns, measured during certain performance intervals and over a certain time frame (e.g., daily returns measured over a two- to four-year time frame). In the case of an asset class comprising index funds, the more relevant performance parameters may be the historical prices or returns of the underlying indices associated with these index funds. This is especially true if one or more index funds in the asset class has only a limited history (e.g., less than two years).

The selection methodology used to select, screen, or winnow the assets in an asset class into a workable number of assets which fairly represent, or can account for the vast majority of, the behavior of the class, may also comprise evaluating one or more financial factors. The evaluation of financial factors thus amounts to the application of one or more “business rules” for selecting one asset and rejecting another, similarly behaving asset in the winnowing process. These financial factors may be any of a number of objective criteria which can be easily compared between two assets and allow for a rational choice. Representative financial factors are market capitalization, liquidity, expense ratio, correlation with the underlying index, or combinations of these factors.

The formulation of an investment performance index as described herein may be performed one time, but normally will be performed multiple times, using the same asset class, over successive time periods, in order to establish a continuing performance benchmark. A typical single time period for assessing the index (and therefore the benchmark performance) has a duration of about three months (i.e., quarterly evaluation of the index). The performance benchmark generated in this manner may be used to gauge the performance of any asset or portfolio of assets in the asset class, or otherwise may be used for comparison against the performance of other types of assets over the same time period or different time periods. In any event, the “investor-centered” feature of a given performance index will be of important benchmarking value for investors sharing the level of risk tolerance that the index is designed to represent.

Other aspects of the invention relate to utilizing the methods discussed herein for formulating an optimized investment portfolio for an asset class. In particular, an investor having a particular risk tolerance can advantageously select a subset of assets from the asset class and invest in this subset, in accordance with the optimized investment weightings associated with that risk tolerance.

These and other aspects of the invention are apparent from the following Detailed Description.

### BRIEF DESCRIPTION OF THE DRAWINGS

FIG. 1 is a flowchart representing an overall process for formulating risk-based or “investor-centered” indices, according to an illustrative embodiment of the invention.

FIG. 2 illustrates a table of a selected subset of exchange-traded index funds according to an illustrative embodiment of the invention.

FIG. 3 illustrates a table of optimized index components for the asset class of exchange-traded index funds according to an illustrative embodiment of the invention.

FIG. 4 illustrates a table of back-testing from March 2004-December 2004 according to an illustrative embodiment of the invention.

FIG. 5 illustrates a table of back-testing from January 2005-December 2005 according to an illustrative embodiment of the invention.

FIG. 6 illustrates a table of back-testing from January 2006-September 2006 according to an illustrative embodiment of the invention.

FIG. 7 is an illustrative data processing architecture suitable for carrying out one or more aspects of the invention.

### DETAILED DESCRIPTION OF THE INVENTION

The methods described herein are applicable to a wide variety of financial assets and asset classes, and particularly to equity and debt securities as well as commodities for which there is an established market and consequently a history of market price and return data. Assets therefore include individual stocks and bonds, as well as stock and bond funds, real estate, commodities, options, etc. which are traded on the various markets (e.g., NYSE, AMEX, NASDAQ, as well as foreign equity and debt markets, various commodity exchanges, etc.). A representative type of asset is an exchange-traded fund. An asset class is a group of assets sharing at least one common feature, such as market capitalization, industry, management type, fund type, growth stage, dividend yield, geographic market, etc. Examples of asset classes are vast and include index funds, large-cap stocks and stock funds, high-yield (e.g., junk) bonds and bond funds, biotechnology stocks and stock funds, real estate investment trusts, precious metals and funds, etc. One exemplary asset class is the class of exchange-traded index funds, and is used herein as a primary example for illustrative purposes.

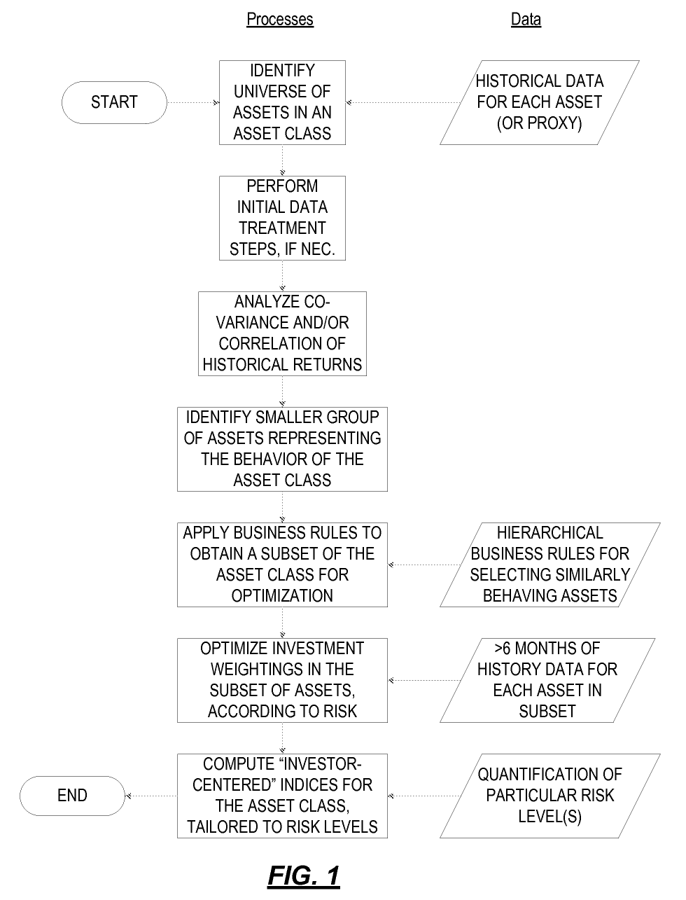

A representative method according to aspects of the invention described herein is illustrated using a flowchart in FIG. 1. The method steps and inputs shown, as described in greater detail below, are intended to facilitate an understanding of the invention, and not to limit the invention, as set forth in the appended claims, to any particular embodiment.

In formulating an investment performance index from an asset class, members of the class must first be identified to determine the “universe” of all assets available in the class. The starting group of assets used initially for the index formulation method may include all assets, but will typically include at least about 80%, and often at least about 90%, of the assets in the asset class. It may be impractical to identify all assets as a starting point or it may otherwise be desirable to initially rule out certain assets from the asset class, for example new issues having a limited price history or assets which are traded to such a small extent that the associated market price is unreliable.

Even in cases where one or more assets are initially excluded, many types of asset classes will embrace a fairly large number of individual assets which might be used to formulate an investment performance index. Asset classes will generally comprise at least 50 assets (e.g., 50-1000 assets), typically at least 100 assets (e.g., 100-750 assets), and often at least about 200 assets (e.g., 200-500 assets). For example, in the case of exchange-traded index funds as a representative asset class, there are currently more than 600 individual members which could potentially be used in formulating an investment performance index, corresponding to approximately 1.6·10⁶⁰ feasible asset combinations. It would therefore be impossible for even the fastest computers to evaluate all possibilities in a reasonable time frame. The methods described herein, however, obviate the need to evaluate all such combinations.

The effective formulation of an investment performance index thus involves the selection of a subset of assets from the asset class in order to obtain a manageable number for subsequent analyses. The subset will generally comprise less than about 25% (e.g., 1%-25%), typically less than about 15% (e.g., 3%-15%), and often less than about 10% (e.g., 5%-10%) of assets in the asset class. A selected subset of the more than 200 exchange-traded index funds, for example, may comprise less than about 30 index funds or even less than about 20 index funds, using the selection methodology described herein.

The subset will ideally represent substantially all of the behavior, or variation, of the asset class as whole with respect to the overall market or market sector and thereby provide a meaningful representation. To ensure the subset is representative, the selection methodology comprises utilizing the covariance or correlation between performance parameters of the initial, starting group of assets (e.g., the 600+ exchange-traded index funds) in the asset class. These performance parameters, which may be input data for one or more computers 701 (FIG. 7, discussed in detail below) programmed to operate in accordance with the methods described herein, generally include historical prices and/or historical returns for each asset. For example, it is normally desirable to obtain at least one year, and typically from about two to about four years, of price and/or return data. It is often advantageous to perform the statistical calculations, necessary for the selection methodology, using daily historical data, but prices and/or returns measured over longer intervals, for example weekly or monthly intervals, may alternatively be used.

In some cases, such as when an asset has insufficient associated performance history, a convenient proxy for the performance parameters may exist and thus be substituted for the actual parameters. Thus, the underlying indices, for example, may be used as a proxy for the historical price and/or return data, in the case of an asset that is an exchange-traded index fund. These underlying indices, because of their high value as modeling or predictive tools, may be considered superior for use in the selection methodology, even when the actual index fund data are available.

If historical price data are available (e.g., in a database or spreadsheet as input data) for assets in the asset class, returns may be easily calculated, for example, using a computer. Other initial algorithms (e.g., computer programs) may be run, for example, to mask out non-trading days, to threshold each day for the number or proportion of missing assets, and/or to threshold each asset for the number or proportion of missing days. Additional tools or algorithms, such as a ladder of powers examination (i.e., a Box-Cox analysis) may be performed to identify a data transform which improves data symmetry and/or unimodality. If an asset lacks data for a specified, user-defined, number of consecutive days, a co-variation preserving process or algorithm known as Expectation Maximization (EM) may be applied to the performance parameter data.

In a particular application of EM, for example, the existing data are used to construct conditional probability density functions by which missing data are conditioned upon existing data. This assumes that the data are jointly or multivariately normal or Gaussian, which provides a justification for using a ladder of powers examination, as discussed above. According to the EM analysis, X may be defined as a vector of p elements distributed multivariately normal with a mean μₚₓ₁ and covariance Σₚₓₚ. It is possible to represent

$$\underline{X} = [ \frac{{\underline{X}}_{1}}{{\underline{X}}_{2}} ]$$

where X₁ are the missing q elements and X₂ are the present (p-q) element. Correspondingly, it is possible to represent

$$\underline{μ} = [ \frac{{\underline{μ}}_{1}}{{\underline{μ}}_{2}} ] , \sum = [ \frac{{\sum }_{11} {\sum }_{12}}{{\sum }_{21} {\sum }_{22}} ]$$

and let det(Σ₂₂)>0. It can be shown that the conditional distribution of X₁ is multivariate normal with

μ_{1|2}=μ₁+Σ₁₂Σ₂₂⁻¹(x₂−μ₂)

Σₓ_{₁}_{|x}_{₂}=Σ₁₁−Σ₁₂Σ₂₂^{-1Σ}₂₁.

Then, using maximum likelihood estimators, it is possible to generate or “fill in” the missing values to update the joint mean and covariance matrix. This analysis may be performed iteratively until the stepwise differences between the joint mean and covariance matrices fall below a user-defined value, which may also be input into the EM algorithm.

Covariance or correlation between performance parameters of the initial, starting group of assets in the asset class is used in the selection of a representative subset of assets for formulation of the index. Both covariance and correlation, having explicit mathematical forms and statistical definitions, are used in financial analysis to describe the extent to which two assets change in common. Assets having a positive correlation, (e.g., two U.S. large-cap stock funds), generally move in the same direction (in tandem) over time. Conversely, negatively correlated assets (e.g., a fund benefiting from high sugar prices and a candy company) move in opposite directions, whereas assets which are uncorrelated are considered independent. The use of covariance or correlation in the selection methodology to identify a subset of assets is therefore based on the elimination of redundancy in information obtained from more than one asset (e.g., information which is explained by the same market forces).

Thus, the behavior of several assets having a high degree of positive correlation or co-variation can often be accounted for by a single asset or at least a smaller number of assets. The selection methodology is therefore based, at least in part, on the fact that at least some, and often a significant proportion, of the assets in an asset class will not respond uniquely, but will instead behave similarly, in response to a change in the overall market. However, assets in an asset class which are negatively correlated with, or even independent of, others generally cannot be discarded from the subset, as they provide distinctive information for the index formulation. In any event, the selection methodology reduces the number of assets in the asset class to a selected, manageable subset of assets which can maintain or describe essentially all patterns of variation observed for the asset class as a whole.

In order to determine a relatively small number of representative assets to include in the subset, therefore, one or more statistical analyses such as factor analysis may be employed. In the case of factor analysis, important details in the patterns of variation (i.e., the manner in which an asset changes over a certain time period with respect to a financial measure of interest) can be masked by trends and cycles in the overall market. Factor analysis therefore involves a regression of the individual assets with respect to major or globally recognized benchmarks, such as the S&P 500 Index, the MSCI World Index, the MSCI World Index EX USA, the FTSE World Index EX USA, and the FTSE World Index. The residuals obtained from a fit of the data to the regression function are then used in further analyses to identify non-market driven patterns of variation.

A matrix of cross-products of these residuals is then created and a principle components analysis, involving factor extraction, followed by a varimax factor rotation, may be used to generate factor loadings. In general, the nature of these rotated factor loadings is such that 1) they describe in one model all, or substantially all, of the variation for all assets in the study and 2) those assets scoring highly positively or highly negatively on the same factor are deemed to vary in a similar way. A small, user-defined number of such assets (on one factor) are thus required to be included in the subset of assets used to determine the investment performance index.

Other aspects of the selection methodology relate to resolving computational issues associated with the factor analysis and/or principal components analysis which may arise if the number of assets in the study (p) is not substantially less than the number of observational periods in the study (n) (i.e., “the n>p issue”). In this case, additional algorithms as part of the selection methodology may include randomly sub-sampling of the assets (without replacement) exhaustively into a small number of groups, followed by performing the factor analysis for each sub-sample and “high-grading” the result. This process may be subsequently repeated as many times as desired until a targeted, or user-defined, number of candidate assets is achieved. Factor models and expectation maximization are known statistical protocols or algorithms for data analysis. They are described, for example, by Johnson, R. A. et al., APPLIED MULTIVARIATE STATISTICAL ANALYSIS, 5^{th} Ed. (2002), herein incorporated by reference.

Overall, therefore, factor analysis and/or other statistical tools based on covariance or correlation, such as principal component analysis, discussed above, or cluster analysis, may be used in the selection methodology. This methodology allows the selection of a subset of assets, from the asset class, which effectively generally accounts for (or explains) at least 90% of the variability, typically at least 95% of the variability, and often at least 98% of the variability, of the asset class as a whole. The extent of correlation between the subset of assets chosen and the overall performance of the asset class is a function of both (1) the degree of covariance among the assets within the asset class and (2) the number of assets selected for the subset. The latter variable may be user-defined, with a higher number of selected assets corresponding to a greater extent of correlation, or explanation of a greater degree of the variability of the entire asset class.

The selection methodology may additionally comprise evaluating one or more financial parameters (i.e., applying “business rules”) in order to select, screen, or winnow the assets in an asset class into a workable number of assets. These financial factors may be any of a number of objective criteria which are normally publicly available and can be readily compared between assets to allow for a rational choice. Representative financial factors, which may be user-defined, include market capitalization, liquidity, expense ratio, and correlation with an underlying index or other financial benchmark. Combinations of factors may also be applied. In the case of liquidity as a financial factor, for example, one asset may be selected over another if the latter fails to meet a user-defined liquidity requirement based on a number of shares or a dollar amount traded per unit time (e.g., 1 million shares, or alternatively 1 million dollars, per day in trading volume). Other business rules may simply invoke the judgment of the user or a third party (e.g., the client) in determining which of two or more similar assets should remain in the selected subset of assets, used in the determination of the investment performance index.

Following an identification of a subset of assets, which may be in the form of output data and received as input data into one or more computer algorithms (e.g., asset weighting optimization algorithms), optimal investment weightings in each of these assets are determined to formulate the performance index for the asset class of interest. The optimal investment weightings may be computed, for example, based on daily price and/or return data for the six-month period preceding the determination of the index value. Thus, for example, if data for the assets are available from the first business day of 2004, an index value may be calculated as of the last business day of June, 2004. If monthly or quarterly index values are desired, the next index values could be calculated as of the last business days of July, 2004 or September, 2004, respectively. Data for computing these subsequent monthly or quarterly index values would be taken from the first business day in February, 2004 until the last business day in July, 2004 or from the first business day in April, 2004 until the last business day in September, 2004. However, data over other intervals (e.g., weekly) or taken over shorter or longer time periods (e.g., over a 1 year period) may also be used in an analogous manner. In any event, the determination of the index values will normally involve the utilization of as much historical, daily data, for all assets in the selected subset, as is available (e.g., data over at least a six-month period preceding the determination of the index).

The methods described herein for formulating or computing an investment index, therefore, may be performed once or repeated multiple times in succession, in order to establish a performance benchmark for an asset class. If the index is formulated successively, for example, over multiple three-month time periods, the subset of selected assets, or even the initial members of the asset class itself, may change in number and in kind. For example, a new asset may come into existence, asset variance and covariance data may change, or other changes may influence the nature of the ultimate index which is formulated. Such changes are associated with the desire to establish and maintain an objective performance benchmark, modeled on the behavior of an investor having a given risk profile (i.e., an “investor-centered” index) and seeking to maintain a well-diversified portfolio for a given asset class. Alternatively, the index may be formulated over several successive time periods (e.g., for four quarters) necessarily using the same subset of selected assets and optimizing investment weightings in these assets, with “re-visitation” of the larger starting group of assets in the asset class occurring over longer intervals (e.g., yearly).

In any event, the performance benchmark may be used to gauge the performance of any number of investments, including those associated with the asset class as well as those potentially associated with any of a number of competing asset classes. Representative investments include individual investment portfolios, target maturity funds, or families of funds over the relevant time periods of interest (e.g., the time periods over which the index is determined).

The choice of whether an investment index should be formulated successively over 1-month intervals, quarterly intervals, or some other intervals, in order to establish a performance benchmark for an asset class, may be based on a review of the index calculated for different intervals and/or on a recommendation of a third party such as an individual investor or an investment firm. Likewise, the type of optimization technique used to determine the optimal investment weightings in each asset of the selected subset may also be determined following an evaluation of the index using a number of different optimization techniques.

Representative optimization techniques or algorithms include Mean Variance Optimization (MVO), Conditional Value at Risk (CVaR), and Generalized Capital Asset Pricing Model (G-CAPM). MVO is described, for example, by Markowitz, H., “Portfolio Selection: Efficient Diversification of Investments” (Cowles Foundation Monograph: No. 16), Yale University Press, 2001. Also see Elton, E. J. et al., MODERN PORTFOLIO THEORY AND INVESTMENT ANALYSIS, 4^{th} Ed., Wiley, NY (1991), pp. 65-93 and Huang, C. J. et al., “Foundations for Financial Economics,” Elsevier, N.Y. (1988), pp. 59-82. CVaR is described, for example, by Uryasev, S., “Conditional Value-at-Risk (CVaR): Algorithms and Applications,” Risk Management and Financial Engineering Lab, University of Florida, 2000. G-CAPM is described, for example, by Malevergne, Y. et al., in “Multivariate Weibull Distributions for Asset Returns: I,” FINANCE LETTERS 2 (6), 16-32 (2004) (http://ssrn.com/abstract=714161) and also in “High-Order Moments and Cumulants of Multivariate Weibull Asset Returns Distributions: Analytical Theory and Empirical Tests: II,” FINANCE LETTERS 3 (1), 54-63 (2004) (http://ssrn.com/abstract=714185). Each of which is herein incorporated by reference.

The general methodology associated with MVO for portfolio design is known in the art and, as discussed below, computer programs exist for determining investment weightings in assets in which the expected return, variance, and covariance with other assets in the portfolio are known or calculated. MVO involves the determination of a minimum-variance frontier, which may be in the form of a plot of the maximum expected return for an index (or portfolio) that is created from a set of assets (in this case the subset of selected assets in the asset class), for each given level of risk, or standard deviation of the index about its expected return. The minimum-variance frontier can therefore appear as a curve on the expected return vs. standard deviation (risk) graph which is specific to the subset of assets selected. Each point on the minimum-variance frontier is associated with a unique set of investment weightings which provide the most efficient tradeoff between risk and return, for a particular level of risk which can be tolerated or, alternatively, for a particular level of expected return that is desired.

The minimum-variance frontier may be calculated without any constraints or may be subject to one or more constraints which limit the potential performance that can be achieved. A common constraint, for example, is the exclusion of short positions (or negative weighting factors) in any of the subset of assets. In this case, the asset with the highest expected return will itself be on the frontier since, by excluding short sales, the only possibility to achieve that expected return is a 100% investment weighting in the single asset. In general, for a minimum-variance frontier that is constrained in this manner to exclude short positions, fewer assets are combined in frontier indices, as the risk-return characteristics of the index increase. Thus, a consequence of the optimization step is commonly a further reduction of the subset of assets selected for the index, into an even smaller group actually used for determining the index value. The optimal weightings for one or more of subset of assets may therefore be zero, especially in the case of index values that are computed for higher levels of risk or expected return.

Other examples of constraints include limitations on the weightings in certain assets or in any one asset. Any types of constraints may be used as input data for an MVO algorithm or other method, including those described herein, for calculating the optimal investment weightings.

A particular point of interest on the minimum-variance frontier for the selected subset of assets is the point corresponding to weightings in the tangency or Sharpe portfolio, which provides the highest level of excess return (above the risk-free rate) per unit of standard deviation. This point therefore represents the index (or portfolio) that, in combination with a risk-free asset (e.g., T-bills), provides a capital allocation line having a maximum slope and which is tangent to the minimum-variance frontier. Thus, one possible index may include a combination of a risk-free asset together with the risky portfolio of assets, along the capital allocation line through the tangency portfolio. In this case, the particular level of risk for which the index is determined would result in a relatively greater or smaller investment in the risk-free asset, with a higher risk tolerance associated with a lower weighting in the risk-free asset.

Alternatively, investment weightings for a given level of risk would, like the tangency portfolio, correspond to portfolios on the minimum-variance frontier (or constrained minimum-variance frontier). In this case, a given risk level could be associated with (or matched to) a divergence from the tangent portfolio, but still be represented by an index (or portfolio) on the frontier. For example, an index could be formulated for a “Slightly Aggressive” investor by diverging from the tangency portfolio by a user-defined increase in either standard deviation or expected return. An additional user-defined increase could be used to compute an index associated with an “Aggressive” investor desiring to invest in the given asset class. Divergences that are one or two set, user-defined, decreases in standard deviation or expected return from the tangency portfolio, could likewise be used to compute indices associated with a “Conservative” or “Very Conservative” investor, respectively, while an index computed using weightings corresponding to the tangency portfolio itself would be associated a “Moderate” investor.

According to an illustrative embodiment, representative steps in using MVO to form an optimized portfolio may be performed as follows. First a library program which utilizes input data that are the six months of daily data for each asset in the selected subset of assets is executed. This program computes the return and standard deviation for a representative number (e.g., about 300) of points along the minimum-variance or efficient frontier. The program additionally provides the tangency or Sharpe portfolio weightings, as well as the return and standard deviation of this portfolio. In the case of a single index, the tangency or Sharpe data are used to formulate an index. Alternatively, if a number of indices are desired (e.g., based upon varying levels of risk), corresponding return and standard deviation associated with these levels of risk are computed or output, using a second library program which utilizes the same input data, but additionally requires a user-defined expected return associated with a given level of risk. The program then determines the optimal investment weightings or allocations for the subset of assets used to formulate the index. This procedure is repeated as needed to obtain each desired, “investor-centered” index.

CVaR is simpler to implement than MVO, and generally requires a user-defined input corresponding to a maximum level of loss or shortfalls, or otherwise one or more levels of losses or shortfalls, not be exceeded by the index more than a specified number of times in a specified time period (e.g., a user-defined input that the index should not incur a 5% monthly loss more than once every 20 months). According to this information regarding tolerable losses, coupled with the same asset return input data as discussed above with respect to the MVO algorithm, the CVaR program computes or outputs the corresponding weights or allocations for the assets in the index. This code exists as a separate library function written by Lipper.

The G-CAPM algorithm outputs one, and only one index, corresponding to the unconstrained best portfolio. The program output therefore cannot be constrained by differing risk levels, although it can be constrained by the investment weighting values. G-CAPM requires the same asset return data as described above with respect to MVO and CVaR and computes the best risk-adjusted index based on a particular number of moments (e.g., the first four moments) of the return distributions. Like CVaR, this also exists as a separate library function written by Lipper.

The optimal investment weightings, which are computed according to methods such as those described above for formulating an investment index, may be determined for a given risk level. This provides “risk-based optimization” of the index, which may therefore be characterized as “investor-centered.” Also, as discussed above, these investment weightings may correspond to a portfolio of the selected subset of assets (used to formulate the index) on a minimum-variance frontier or a constrained minimum-variance frontier (e.g., which excludes negative weighting values). According to some embodiments, a particular risk level for an index may be associated with a divergence from a tangent portfolio on this frontier.

A variety of ways of quantifying a risk level for investment performance index will be apparent to one of ordinary skill, having regard for the present disclosure. The standard deviation, or alternatively, the expected return, of the index could be a basis for quantifying risk. In such cases, various indices could be computed based on minimum-variance (or constrained minimum-variance) portfolios of the subset of selected assets, with particular standard deviations or expected returns. Likewise, indices could be formulated based on minimizing expected shortfall or levels of losses such as can be achieved via CVaR. Or particular types of risk, such as those referred to as the tilt or skewness of the portfolio, can be maximized or minimized via G-CAPM.

For purposes of formulating an “investor-centered” index as described herein, risk could be alternatively quantified, as an input to an optimization algorithm, according to other measures. For example, as discussed above with respect to the CVaR algorithm for optimization of investment weightings, a maximum loss, or a maximum number of losses of a certain magnitude over a certain time frame, may also be suitable methods for quantifying risk and thereby associating or matching a level of risk to a particular index. Additional measures for quantifying risk include determining a coefficient of risk aversion. This coefficient is used to approximate utility, or welfare, assigned to competing investment portfolios based on an investor's willingness to trade off higher risk for a higher level of expected return. Examples of utility functions (or indifference curves) and a description of their significance are found, for example, in Bodie, Z. et al., INVESTMENTS, 4^{th} Ed., Irwin McGraw-Hill, (1999), pp. 151-155, herein incorporated by reference. The maximization of a utility function according to the asset allocations available on a particular capital allocation line between a risk-free asset and the tangency portfolio is also described in this text at pages 186-189. Similarly, it is also possible, for example using computer algorithms, to maximize a given investor utility function according to asset allocations available on a minimum-variance frontier. In either case, the risk level, used to compute the index, is a user-defined coefficient of risk aversion, which can be a computer program input, and the optimal investment weightings are determined based on maximization of a utility function that utilizes this coefficient of risk aversion.

Various other measures for risk quantification are known and would be equally applicable for the formulation of indices according to the methods described herein. Risk levels are normally associated with (or matched to) various factors such as the prior investment behavior of an investor, age, time to retirement, financial status, the contribution of a particular investment portfolio to overall wealth, personal preferences, etc. The relevant investor information is often obtained from financial advisors or other professionals through questionnaires, surveys, interviews, analysis, etc. This information may in some cases therefore form part of the input data used in the determination of optimal investment weightings.

According to other aspects of the invention, the methods described herein may alternatively be used to formulate an optimized investment portfolio for an asset class. In carrying out these methods, an investor would invest in the subset of selected assets according to the optimal investment weightings, where the subset and weightings are determined as discussed above. In this case, the investor's risk level or desired level of risk, quantified according to any suitable method, including those specifically discussed above, would be determinative of the optimal weightings.

With reference to FIG. 7, the methods, method steps, and method sub-steps described herein, which include selecting a subset of assets (which may involve, for example, calculating returns masking out non-trading days, thresholding each day for missing assets, thresholding each asset for missing days, a ladder of powers examination, an expectation maximization, factor analysis, principal components analysis, and/or cluster analysis) and optimizing investment weightings (which may involve, for example, MVO, CVaR, and/or G-CAPM), may be implemented as a computer program product 717, or combination of computer program products, for use with a computer system. Above descriptions of “input data” and various “user-defined” parameters are examples of possible inputs to such computer programs. The various methods and method steps described above which “provide,” “generate,” “formulate,” “compute,” or “create” parameters are examples of parameters which may be output from a computer program (e.g., in the form of a value displayed on a computer screen, or printed by a printer).

Computer 701 represents a generic computing device, e.g., a desktop computer, laptop computer, notebook computer, network server, portable computing device, personal digital assistant, smart phone, mobile telephone, distributed computing network device, or any other device having the requisite components or abilities to operate as described herein. Computer 701 may include central processing unit or other processor 703, RAM or other volatile memory 705, ROM or other boot memory 707, network interface(s) 709 (e.g., Ethernet, wireless network interface, modem, etc.) through which computer 701 connects to a network (e.g., Internet, LAN, WAN, PAN, etc.), input/output port(s) 711 (e.g., keyboard, mouse, monitor, printer, USB ports, serial ports, parallel ports, IEEE 1394/Firewire ports, and the like), and non-volatile memory 713 (e.g., fixed disk, optical disk, holographic storage, removable storage media, flash drive, etc.). Computer 701 may store various programs, application, and data in memory 713, including, but not limited to, operating system software 715, asset analyzer software 717, data 719 (e.g., historical data and other data described herein), and other application(s) 721.

Computer program product implementations may include a series of computer instructions fixed either on a tangible medium, such as a computer readable medium (e.g., a diskette, CD-ROM, ROM, DVD, fixed disk, etc.) or transmittable to computer system 701, via a modem or other interface device 709, such as a communications adapter connected to a network over a medium, which is either tangible (e.g., optical or analog communication lines) or implemented wirelessly (e.g., microwave, infrared, or other transmission techniques). The series of computer instructions may embody all or part of the functionality with respect to the computer system, and can be written in a number of programming languages for use with many different computer architectures and/or operating systems, as would be readily appreciated by one of ordinary skill. The computer instructions may be stored in any memory device, such as a semiconductor, magnetic, optical, or other memory device, and may be transmitted using any communications technology, such as optical infrared, microwave, or other transmission technology. Such a computer program product may be distributed as a removable medium with accompanying printed or electronic documentation (e.g., shrink wrapped software), preloaded with a computer system (e.g., on system ROM or fixed disk), or distributed from a sever or electronic bulletin board over a network (e.g., the Internet or World Wide Web). Various embodiments of the invention may also be implemented as hardware or a combination of both software (e.g., a computer program product) and hardware.

Throughout this disclosure, various aspects are presented in a range format. The description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual whole and fractional numbers within that range, for example, 1, 2, 2.6, 3, 4, 5, and 6. This applies regardless of the breadth of the range.

In view of the above, it will be seen that several advantages may be achieved and other advantageous results may be obtained. As various changes could be made in the above compositions and methods without departing from the scope of the present disclosure, it is intended that the disclosure of these compositions and methods in this application shall be interpreted as illustrative only and not limiting in any way the scope of the appended claims.

The following example is set forth as representative of the present invention. This example is not to be construed as limiting the scope of the invention as other equivalent embodiments are apparent in view of the present disclosure and appended claims.

### EXAMPLE 1

Investment performance indices were formulated according to methods described herein for the asset class of exchange-traded index funds, comprising over 200 individual assets. A subset of these assets was selected after performing a factor analysis, as described above, utilizing the prior two years of historical daily price data for either the asset itself of the underlying index associated with a given index fund. The factor analysis effectively reduced the starting group of over 200 assets to only 58 funds that explained the vast majority of the price movement of the overall asset class.

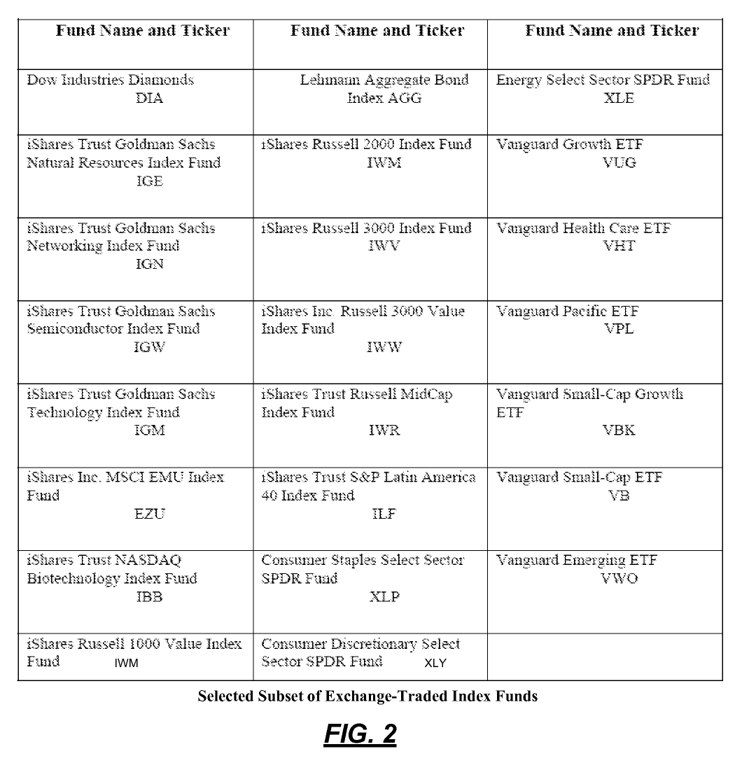

The factor analysis was followed by the application of business rules to this set of 58 funds, in order to ensure that the subset of funds ultimately selected for computing the index were good, tradable instruments. In particular, funds were selected with a minimum liquidity, quantified as at least $1 million traded daily, on average for the 30 days prior to the date for which the index was computed. Additionally, as part of the business rule application, if multiple versions of the same index fund existed, then the fund(s) with relatively low expense ratios and/or relatively high correlation to their underlying index, were selected. In this manner, the starting group of over 200 individual assets was winnowed to a selected subset of only 23, which are shown in FIG. 2.

A review of this list indicates that it represents a diverse subset of funds available for investment, with a representative sampling of U.S. large-, mid-, and small-cap index funds, some value and growth index funds, and a number of index funds in sectors that are known to hold their value (such as consumer staples), as well as more-speculative index funds such as the iShares Networking Index Fund.

Bond index funds are not strongly represented, due to the lack of liquidity in this type of asset. However, because the “investable universe” of the asset class is revisited periodically (e.g., yearly), the list of available bond index funds could become more substantial over time.

Following the selection of the above subset of representative assets, the investment weightings were optimized to compute indices tailored to particular levels of risk. Using daily price data for a three- to six-month period, starting in January 2004 and preceding the determination of the index value, the optimal investment weightings were computed using mean-variance optimization. In particular, the MVO algorithm taken from the fPortfolio library of the R computer program language was used to compute the weightings corresponding to the tangency or Sharpe portfolio for the selected assets, subject to the constraint that short positions in any asset were excluded. This Sharpe portfolio was the basis for an index optimized for an investor having a risk level characterized as “Moderate.”

Investment weightings in two additional portfolios having higher risk/return characteristics by a predetermined amount, but still on the minimum-variance frontier, were used to compute additional indices optimized for investors having “Slightly Aggressive” and “Aggressive” risk levels or “risk appetites.” The investment weightings were calculated using the R program portfolioMarkowitz which required user-defined expected returns exceeding that associated with the Sharpe portfolio by a predetermined amount. Similarly, investment weightings for two more portfolios having lower risk/return characteristics by a predetermined amount, also on the minimum-variance frontier, were used to compute indices optimized for investors having “Conservative” and “Very Conservative” risk profiles.

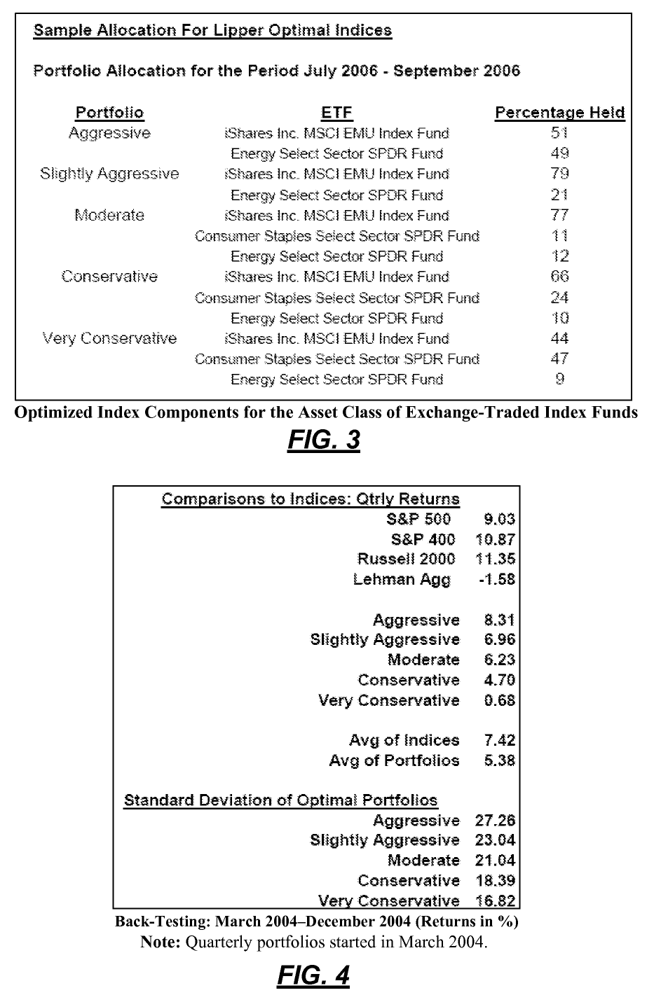

Results of using these methods, according to various embodiments of the invention, and in particular the components selected for the Lipper Optimized Indices for the period from July 2006 to September 2006, are shown in FIG. 3. FIG. 3 provides the percentages each exchange-traded fund held in computing the index associated with each of the five risk profiles described above. Although the same exchange-traded funds in this example were represented in all of the portfolios, the varying percentages of each fund were tailored to the particular associated risk appetite. It was also noted that, as a consequence of the MVO methodology, the selected subset of 23 assets was reduced to a smaller number of assets used in the actual computation of the indices (i.e., the optimal weightings in some of the selected subset of assets, especially for indices associated with higher levels of risk and return, were determined to be zero).

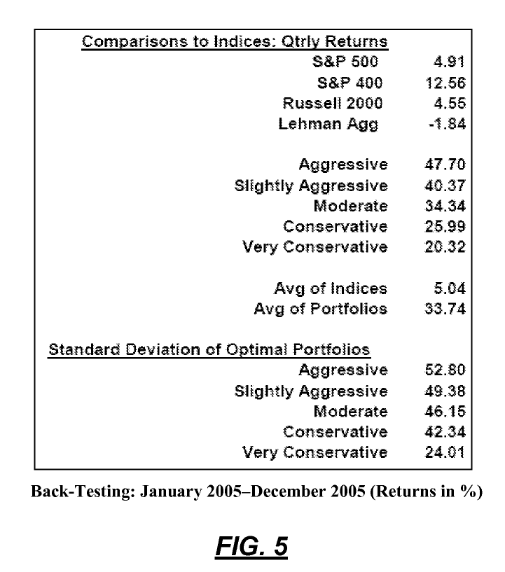

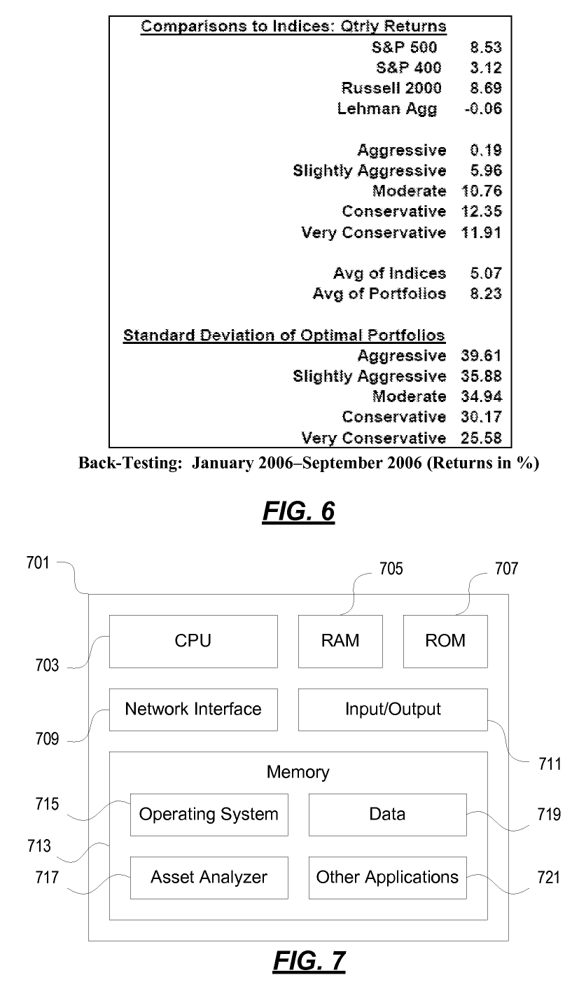

Using mean-variance optimization, both return and standard deviation may be targeted, user-defined, input parameters associated with a given risk level. In most, if not in all, cases, index standard deviation will be the highest for the Aggressive index (or portfolio) and the lowest for the Very Conservative index. Over ten quarters of “back-testing” with the available data (i.e., from the second quarter 2004 through the third quarter 2006), this was accurate, except in fourth quarter 2004, when all the standard deviations were very similar. FIGS. 4-6 show the back-testing results, in which indices were computed in a similar manner but corresponded to earlier time periods.

The results in FIGS. 4-6 illustrate the formulation of “investor-centered” indices according to the methods described herein. For the 2004 results, the asset selection/MVO optimization methodology used only limited historical data. Financial data for the selected assets over a prior, six month period (the minimum generally considered for the formulation of reliable MVO portfolios and associated indices) were not available until the third quarter of 2004. This is potentially one reason why the portfolios formed as of the end of second quarter and first quarter 2004 lagged their benchmark indices.

In 2005 and 2006, the indices, computed using MVO, handily beat their benchmarks, both on an annual and on a quarter-by-quarter basis. This may have been due to the longer time period of the dataset and/or the success in late 2005 of Vanguard Pacific and Vanguard Emerging, two exchange-traded funds selected for computing the indices and optimized, in terms of their representation in each of the “investor-centered” indices, using MVO.

A set of optimized indices for the asset class of exchanged-traded funds and covering a spectrum of investor risk, has been successfully created and tested. Each of these indices comprises a set of the best funds, invested in with the best weightings, with “best” referring to the highest return for a given level of risk, associated with each index.

The optimized indices, as discussed above, can be used for both benchmarking and fund construction purposes. Also, the methodologies used to construct the indices can easily be extended to other markets, such as Europe and Asia, where optimized indices can similarly be constructed.

What is claimed is:

1. A method, comprising:
(a) selecting a subset of assets from an asset class by
(i) identifying a plurality of assets that represent a behavior of the asset class as a whole, and including said plurality of assets in the subset of assets, wherein said plurality of assets is fewer than the number of assets in the asset class; and
(ii) applying one or more business rules to the plurality of assets to remove one or more assets having unreliable historical data from the subset of assets;
(b) determining an optimal investment weighting corresponding to each asset in said subset of assets; and
(c) generating an investment performance index for the asset class based on the optimal investment weighting of each asset in the subset of assets.

2. The method of claim 1, wherein said asset class comprises exchange-traded funds (ETFs).

3. The method of claim 2, further comprising (d) generating a plurality of investment performance indexes for the asset class based on a plurality of investment risk levels.

4. The method of claim 3, wherein each of the plurality of investment performance indexes comprises an optimal investment weighting corresponding to each asset in said subset of assets based on the corresponding investment risk level.

5. The method of claim 1, wherein said optimal investment weightings are determined for a predetermined risk level.

6. The method of claim 5, wherein said risk level is quantified based on the second moment or a higher moment of the distribution of returns of said investment performance index.

7. The method of claim 1, wherein said investment weightings correspond to a portfolio of said subset of assets on a minimum-variance frontier or a constrained risk-return frontier obtained from optimization using CVaR or G-CAPM.

8. The method of claim 1, wherein said subset of assets is selected according to a selection methodology comprising utilizing the covariance or correlation between performance parameters of assets in said asset class.

9. The method of claim 8, wherein said covariance or correlation between performance parameters is utilized in one or more statistical analyses selected from the group consisting of principal component analysis, factor analysis, and cluster analysis.

10. The method of claim 8, wherein said performance parameters comprise historical prices or returns of said assets in said asset class.

11. The method of claim 8, wherein said asset class comprises one or more index funds and said performance parameters comprise historical prices or returns of indices associated with said one or more index funds.

12. The method of claim 8, wherein said selection methodology further comprises evaluating one or more financial parameters to winnow said asset class.

13. The method of claim 8, wherein said financial factors are selected from the group consisting of market capitalization, liquidity, expense ratio, and combinations thereof.

14. The method of claim 1, wherein said investment weightings correspond to a portfolio of said subset of assets on a minimum-variance frontier or a constrained risk-return optimization of said subset of assets.

15. The method of claim 14, wherein said constrained minimum-variance frontier or constrained risk-return optimization excludes short positions in any of said subset of assets.

16. A method for establishing a performance benchmark for an asset class, the method comprising formulating an investment performance index for said asset class according to claim 1 over a time period or over a succession of multiple time periods.

17. The method of claim 16, wherein said time period is about three months.

18. The method of claim 16, further comprising gauging the performance of an individual investment portfolio, a target maturity fund, or a family of funds over said time period, based on said performance benchmark.

19. A method of formulating an optimized investment portfolio for an asset class, the method comprising formulating an investment performance index for said asset class according to claim 1 and investing in said subset of assets, according to said optimal investment weightings, determined for a given risk level, for each asset in said subset of assets.

20. One or more tangible computer readable media storing executable instructions that, when executed, cause a data processing system to perform a method comprising steps of:
(a) selecting a subset of assets from an asset class by
(i) identifying a plurality of assets that represent a behavior of the asset class as a whole, and including said plurality of assets in the subset of assets, wherein said plurality of assets is fewer than the number of assets in the asset class; and
(ii) applying one or more business rules to the plurality of assets to remove one or more assets having unreliable historical data from the subset of assets;
(b) determining an optimal investment weighting corresponding to each asset in said subset of assets; and
(c) generating an investment performance index for the asset class based on the optimal investment weighting of each asset in the subset of assets.

21. The computer readable media of claim 20, wherein said asset class comprises securities.

22. The computer readable media of claim 20, said method further comprising (d) storing a plurality of calculated investment performance indexes for the asset class based on a plurality of investment risk levels.

23. The computer readable media of claim 22, wherein each of the plurality of investment performance indexes comprises an optimal investment weighting corresponding to each asset in said subset of assets based on the corresponding investment risk level.

24. The computer readable media of claim 20, wherein said optimal investment weightings are determined for a predetermined risk level.

25. The computer readable media of claim 24, wherein said risk level comprises a standard deviation about an expected return of said investment performance index.

26. The computer readable media of claim 25, wherein said investment weightings correspond to a portfolio of said subset of assets on a minimum-variance frontier or a constrained risk-return optimization obtained from mean-variance optimization of said subset of assets, and said risk level is associated with a divergence from a tangent portfolio on said minimum-variance frontier.

27. The computer readable media of claim 26, wherein said risk level is a coefficient of risk aversion and said optimal investment weightings are determined based on maximization of a utility function utilizing said coefficient of risk aversion.

28. The computer readable media of claim 20, wherein said subset of assets is selected according to a selection methodology comprising utilizing the covariance or correlation between performance parameters of assets in said asset class.

29. The computer readable media of claim 28, wherein said covariance or correlation between performance parameters is utilized in one or more statistical analyses selected from the group consisting of principal component analysis, factor analysis, and cluster analysis.

30. The computer readable media of claim 28, wherein said performance parameters comprise historical prices or returns of said assets in said asset class.

31. The computer readable media of claim 28, wherein said asset class comprises one or more index funds and said performance parameters comprise historical prices or returns of indices associated with said one or more index funds.

32. The computer readable media of claim 28, wherein said selection methodology further comprises evaluating one or more financial parameters to winnow said asset class.

33. The computer readable media of claim 28, wherein said financial factors are selected from the group consisting of market capitalization, liquidity, expense ratio, and combinations thereof.

34. The computer readable media of claim 20, wherein said investment weightings correspond to a portfolio of said subset of assets on a minimum-variance frontier or a constrained minimum-variance frontier of said subset of assets.

35. The computer readable media of claim 20, wherein said constrained minimum-variance frontier excludes short positions in any of said subset of assets.

36. The computer readable media of claim 21, wherein said securities consist of exchange traded funds (ETFs).

37. One or more tangible computer readable media storing executable instructions that, when executed, cause a data processing system to perform a method comprising steps of:
(a) selecting a subset of exchange traded funds (ETFs) from available ETFs by
(i) identifying a plurality of ETFs that represent a behavior of available ETFs, and including said plurality of ETFs in the subset of ETFs, wherein said plurality of ETFs is fewer than the number of available ETFs; and
(ii) applying one or more business rules to the plurality of ETFs to remove one or more ETFs having unreliable historical data from the subset of ETFs;
(b) determining an optimal investment weighting corresponding to each ETF in said subset of ETFs;
(c) generating an initial ETF investment performance index based on the optimal investment weighting of each ETF in the subset of ETFs; and
(d) generating a plurality of additional ETF investment performance indexes based on a plurality of corresponding investment risk levels, wherein each said risk level comprises a standard deviation about an expected return of said initial investment performance index.
